(19) United States
(12) Patent Application Publication
(10) Pub. No.: US 2018/0360679 A1
(43) Pub. Date: Dec. 20, 2018

(54) WHEELCHAIR SEAT

(71) Applicant: David Blomqvist, Stockholm (SE)

(72) Inventor: David Blomqvist, Stockholm (SE)

(21) Appl. No.: 16/064,449

(22) PCT Filed: Dec. 20, 2016
(86) PCT No.: PCT/SE2016/051295

§ 371 Date: Jun. 20, 2018

(30) Foreign Application Priority Data
Dec. 21, 2015 (SE) 1551695-8

(51) Int. Cl. A61G 5/10

(52) U.S. Cl. CPC A61G 5/1056; A61G 5/1091

(57) ABSTRACT

The present specification relates to an adjustable seat for a wheelchair, the seat being adapted to be removably arranged in the wheelchair, the seat comprising a first rolling element, a carrying element, a supporting structure adapted to support the first rolling element and the carrying element, an endless belt, at least one of the first rolling element and the endless belt further comprising means for providing an engagement between the first pulley and the endless belt, and means for applying a rotational motion to the first rolling element. The first rolling element is arranged to be rotatably supported by the supporting structure, the endless belt is adapted to rotate about the first rolling element and the carrying element, wherein the first rolling element is a drive rolling element adapted to transfer a rotational motion induced by said means for applying a rotational motion to said at least one first rolling element to said endless belt. The present specification further relates to a wheelchair comprising such a seat.

### TECHNICAL FIELD

The present invention generally relates to wheelchairs and accessories therefore, and more particularly to a seat for a wheelchair. The present invention further relates to a wheelchair comprising said seat.

### TECHNICAL BACKGROUND

Wheelchairs are known in the field of medical aids and are used by patients for mobility reasons, and many types of wheelchairs are used depending on the needs of the user for example depending on the type of disability. Examples include manual wheelchairs, motorized wheelchairs, and wheelchairs intended to be operated by a care giver.

Common to most types of wheelchairs is that some users, for example elderly users, tend to slide forwards in the wheelchair into an inclined, or leaning, position after being seated in the wheelchair for a period of time. Apart from being uncomfortable to the user, the risk prevails that the user may fall from the chair if sliding too far out over a front edge of the wheelchair.

A common solution to this problem for example in care facilities is that the user is lifted manually in order to regain a proper position in the wheelchair. This is however uncomfortable for the user and heavy for the care giver and further imposes a risk of injuries to both care givers and users.

In order to alleviate some of these drawbacks, attempts have been made to provide electrical lifting aids, such as for example portable patient lifts to facilitate repositioning of patients, but such aids tend to be expensive and complicated to use. Further, such lifting aids are often not very convenient when operated by the user of the wheelchair. This is a serious drawback since it does not allow a user to independently adjust the seating position.

### SUMMARY OF THE INVENTION

Accordingly, it would be desirable to provide an improved seat for a wheelchair. In particular, it would be desirable to provide a convenient and simple way of adjusting the seating position of a user in a wheelchair. To better address one or more of these concerns a removable seat for a wheelchair and a wheelchair as defined in the independent claim is provided. Preferred embodiments are defined in the dependent claims.

According to a first aspect of the invention an adjustable seat for a wheelchair is provided, the seat being adapted to be removably arranged in the wheelchair. The seat comprises a first rolling element, a carrying element, a supporting structure adapted to support said first rolling element and said carrying element, an endless belt, said belt comprising an inner and an outer surface, said inner surface being adapted to face said first rolling element and said carrying element, at least one of the first rolling element and the endless belt further comprising means for providing an engagement between said first rolling element and said endless belt, and means for applying a rotational motion to said first rolling element. At least a portion of the first rolling element is arranged to be rotatably supported by said supporting structure, the endless belt is adapted to rotate about said first rolling element and said carrying element, and the first rolling element is a drive rolling element adapted to transfer a rotational motion induced by said means for applying a rotational motion to said at least one first rolling element to said endless belt.

According to the first aspect, the seat provides an inventive solution to the concerns described above derived from the realization that the desired functionality may be provided by a design incorporating an endless belt adapted to be rotated about a first rolling element and a carrying element. The user may be positioned, or seated, on the outer surface of the endless belt such that the position of a user may be adjusted upon rotation of the endless belt. Further, the first rolling element may be a driving rolling element such that a rotational movement of said endless belt about said driving rolling element and said carrying element may be induced by means of the means for applying a rotational motion to said at least one first rolling element. Accordingly, the position of the user may be adjusted by means of a rotation applied to the first rolling element.

Hereby, the position of the user in the wheelchair may be adjusted in a convenient and simple manner. Accordingly, advantages of the invention include that the comfort of the user is improved and that handling and repositioning of a user in a wheelchair is significantly facilitated, for example with regards to an adjustment of the seating position. Further, as a consequence, known health issues associated with a less adequate seating position such as back ache, pressure sores and pneumonia may also be mitigated.

The disclosed seat is suitable for any type of wheelchair wherein a need prevails to adjust the seating position of the user; examples include for examples wheelchairs for elderly users. Depending on the type of wheelchair, different dimensions of the seat may be suitable, the dimension are however easily adapted for example by means of a change of the length or width of the first rolling element and/or the endless belt. Further, with regards to the height of the seat, i.e. the dimension of the seat in a, when arranged in the wheelchair, vertical direction, the height must be kept sufficiently low both with regards to safety of the patient but also convenience. For example, the user must be able to sit down on the seat without inconvenience and users of manual wheelchairs must be able to have access to the wheels in a comfortable manner. In other words, the height of the seat may in many embodiments preferably be kept low. Accordingly, it will be appreciated that the seat may be dimensioned such that it may under certain circumstances be used in or on other types of structures comprising similar dimensions to those of wheelchairs, such as other arrangement adapted to receive a sitting person.

Further, it will be appreciated that the seat is not limited to a wheelchair. Instead the seat may in alternate examples be used for example in a bed. I.e. one further example is the use of a mechanism according to the independent claims in a bed, for example a hospital bed. Such a mechanism may for example be similarly configured to the seat. Hospital beds commonly comprise adjustable upper, i.e. head, ends, commonly such head ends may be vertically adjustable. A user positioned in the bed may under some circumstance slide downwards in the bed for example due to a disability, much like the situation described in connection with wheelchairs above. In such a situation, the joint or “bent” of the bed i.e. the starting point of the adjustable portion may become incorrectly positioned with respect to the user. For example the joint may positioned approximately at the middle portion of the back of the user and not at the proper position of the hip. Repositioning of patients in this situation is a common, but heavy and inconvenient, task in care facilities and hospitals which may be considerably facilitated using a device according to the independent claims.

A wheelchair commonly comprises a number of wheels, commonly four, a seat and a back rest of some kind. Commonly at least two wheels are fixed, i.e. the axis of rotation of the wheel is fixed with respect to the seat of the wheelchair. A first direction F may be defined as a straight forward direction of movement of the wheelchair. A second opposite direction R may be described as a rearwards direction. A third direction T may be defined as a direction parallel to the axis of rotation of the fixed wheels. A vertical direction V may be defined normal to a plane coinciding with the seat of the wheelchair. The dimension of the seat along the axis F/R, when arranged in the wheelchair, may be referred to as a length of the seat, the dimension of the seat along the axis T, when arranged in the wheelchair, may be referred to as a width of the seat and the dimension of the seat along the axis V, when arranged in the wheelchair, may be referred to as a height of the seat. This applies throughout the present specification.

The seat may be adapted to be removably arranged in the wheelchair. In some embodiments, the seat may be placed on top of an existing seat. This may for example be advantageous for foldable wheelchairs, such wheelchairs commonly comprise a foldable seat, for example a fabric set, on which the seat may be arrange. In other embodiments, the seat may be adapted to replace the existing seat of the wheelchair. Such an embodiment may be advantageous in that the weight of the wheelchair together with the seat may be reduced.

In some embodiments, the seat further comprises means for attaching, or securing the seat to the wheelchair. Examples include straps or Velcro. In some embodiments, a suitable joint comprising a snap lock may be arranged between the wheelchair and the seat, such that the seat may be easily and quickly secured to and removed from the wheelchair.

The first rolling element, or roller, may comprise a uniform cylindrical shape. In one embodiment, the first rolling element comprises an axel and a plurality of cylindrical portions arranged along the axle which portions may be arranged at a distance from one another along the axle. For example, the cylindrical portion may comprise an outer diameter which is larger than the diameter of the axle of the rolling element. In one embodiment the first rolling element comprises a plurality of cog wheels arranged on an axle. In some embodiments the rolling element may comprise a fix axle around which a cylindrical portion of the rolling element may rotate. In other embodiments, the axle of the rolling element rotates with the cylindrical portion of the rolling element. In some embodiments, the first rolling element may be referred to as a roller, in some embodiments a pulley.

The carrying element is an element about which the endless belt may rotate. The carrying element may for example comprise a surface having properties facilitating a sliding movement of the endless belt over the surface, i.e. a surface such that a low coefficient of friction may be achieved. In some embodiments, the carrying element may be rotatably arranged.

The first rolling element is further arranged such that at least a portion of the rolling element may be rotatably supported by the supporting structure, i.e. the supporting structure is arranged, or adapted, to rotatably support at least a portion of the first rolling element. One example is a structure comprising a hole by which the axis of the first rolling element may be rotatably supported. In some embodiments however, the supporting structure may be arranged to fixedly support an axle of the rolling element, such that a movable portion of the rolling element may rotate around the fix axel held in place by the supporting structure.

According to one embodiment, the first rolling element is arranged to be rotatably supported by the supporting structure, i.e. the supporting structure is arranged, or adapted, to rotatably support at least the first rolling element.

An endless belt is provided to rotate about the first rolling element and the carrying element, thereby transferring a user in at least a first direction of movement. A seating area may be formed by the portion of the endless belt extending between the first rolling element and the carrying element on an upper side of the seat, i.e. a side of the seat adapted to face the user. As the belt rotates about the rolling element and the carrying element, the portion of the belt extending between the rolling element and the carrying element forming the seating area may change or shift, for example translate, such that a point P of the endless belt may move along the seating area in a substantially horizontal direction, i.e. translate, along the length of the seat from the first roller to the carrying element or vice versa. The seating area may further be formed by a second opposite side of the endless belt as compared to the first side adapted to face the rolling element and carrying element. The endless belt may be adapted to rotate about said first rolling element and said carrying element in a first and a second opposite direction of rotation.

The first rolling element is a driving rolling element, i.e. a rolling element adapted to drive the rotation of the elongated belt about the first rolling element and the carrying element. In other words a rotation of the endless belt may be induced by means of the first rolling element, i.e. the driving rolling element. At least one of the second rolling element and the endless belt may further comprise means for providing an engagement between said second rolling element and said endless belt. Such means are advantageous for example in that a reliable transfer of power and/or movement may be provided, such that any slip is avoided. Examples include means for providing a frictional engagement between the endless belt and the rolling elements and/or carrying elements, and means for providing a releasable mechanical attachment there between.

The first rolling element may also be referred to as a drive pulley, or drive roller. The seat may further comprise means for applying a rotational movement, or motion, to the first rolling element. Such means may include manual means such as a lever, a handle, a crank, or a hand grip by means of which the user may rotate the rolling element and consequently provide a rotation about the first rolling element and the carrying element to the endless belt. In some embodiments, the seat comprises automatic means such as an electric motor adapted to apply a rotation to the first rolling element. Such means may further comprise a control unit and a user interface.

Suitable materials for the load bearing structure of the seat, i.e. mainly the rolling element, carrying element and supporting structure, include materials providing high structural strength and low weight. Examples of such materials include a metal such as aluminium, or a composite material. The endless belt may in some embodiments comprise a softer, more flexible material such as plastic or rubber.

In other words, the seat may be adapted to be arranged in a wheelchair such that a user may be transferred or translated, in at least a first direction. This translation may be achieved by means of a rotation of the first rolling element which in turn implies a rotational movement of the endless belt. Hereby, the user seated on the seating area may be translated forwards or backwards depending on the direction of rotation. A rotation of the first rolling element in a forward direction may imply a translation of the user in the forward direction and vice versa. Accordingly, the seat may be adapted to be arranged in the wheelchair such that the axis of rotation of the first rolling element is substantially parallel to the axis of rotation of the fixed wheels.

When in use, the seat may be placed in, or on, an existing seat of for example a wheelchair. The user may be positioned, i.e. seated on top of the seating area formed on, or by, the endless belt. Further, the user may initially be seated on the seat in what may be referred to as a proper initial position wherein the behind and thighs are supported by the seat and the back is rested on and substantially parallel to the back rest. As is commonly the case, for example among elderly users, the user tends to over time slide forwards over the seat. Accordingly, after a period of time, the user may be positioned in a less favourable position wherein the behind of the user has moved forwards towards a front edge of the seat and the bottom and the thighs are no longer properly supported by the seat. Such a position is apart from uncomfortable and non-ergonomic for the user also potentially hazardous since the user may easily fall of the wheelchair by sliding over the front edge of the seat.

In the exemplary case of the user involuntary sliding forwards on the seat, i.e. in the forward direction of travel of the wheelchair, a rotation may be applied to the first rolling element using the provided means such that the endless belt rotates about the first rolling element and the carrying element until the proper position of the user is again achieved.

Another exemplary case wherein the seat may be used is a patient who is about to rise, i.e. stand up, from the wheelchair. In such a case the endless belt may be rotated in an opposite direction such that the patient is transferred towards the forward edge of the wheelchair such that standing up may be facilitated, or aided.

Accordingly, due to the functionality provided by the invention according to the independent claims, the user may be easily transferred along the seat, for example back to a preferred initial position, by means of a translational movement of the seating area on the endless belt provided by the rotational movement of the first rolling element induced for example by the user or by a care giver.

According to one embodiment, the first rolling element is a drive rolling element such that a rotational movement of said endless belt about said driving rolling element and said carrying element may be induced by means of said means for applying a rotational motion to said at least one first rolling element.

According to one embodiment, the first rolling element is adapted to transfer a rotational motion from said means for applying a rotational motion to said endless belt, such that a rotational movement of said endless belt about said driving rolling element and said carrying element may be induced by means of said means for applying a rotational motion to said at least one first rolling element.

According to one embodiment, the first rolling element is a drive rolling element adapted to transfer a rotational motion from said means for applying a rotational motion to said endless belt.

According to one embodiment, the carrying element may be a second rolling element rotatably supported by said supporting structure. In such an embodiment, the rotation of the endless belt may be facilitated as compared to a case when the belt slides over the carrying element. The second rolling element may comprise a uniform cylindrical shape. In some embodiments the second rolling element may comprise a fix axle around which for example a cylindrical portion of the rolling element may rotate. In other embodiments, the axle of the second rolling element rotates with a cylindrical portion of the second rolling element. The supporting structure may be arranged, or adapted, to rotatably support the second rolling element. One example is a structure comprising a hole by which the axis of the second rolling element may be rotatably supported. In some embodiments however, the supporting structure may fixedly support an axle of the second rolling element, such that a movable portion of the second rolling element may rotate around the fix axel held in place by the supporting structure. In some embodiments, the second rolling element may be referred to as an idler pulley. In yet other embodiments, the second rolling element may be a driving rolling element, or a drive pulley. Suitable means may be applied to apply a rotational movement to such a second drive rolling element.

According to one embodiment, at least one of the second rolling element and the endless belt further comprises means for providing an engagement between said second rolling element and said endless belt. Such means are advantageous for example in that a reliable transfer of power and/or movement may be provided, such that any slip may be avoided. Examples include means for providing a frictional engagement between the endless belt and the rolling elements and/or carrying elements, means for providing a releasable mechanical attachment there between.

According to one embodiment, the means for providing an engagement between said first rolling element and said endless belt comprise projections arranged on at least one of the first rolling element and the endless belt and corresponding depressions arranged on at least one of the first rolling element and the endless belt. One example of such means are ribs extending along the first and second rolling element and/or carrying element and corresponding grooves arranged on the first side of the endless belt. In one embodiment, the grooves may be arranged on the rolling element(s) and the ribs on the endless belt. The grooves and/or the ribs may be continuous along the length of the rolling element(s) and/or the width of the belt, or may in some embodiments be discontinuous forming for example lugs or shoulders. In one embodiment, at least the first rolling element comprises a cog wheel shaped cross section, and the endless belt comprises a corresponding “gear rack” structure. In one embodiment, the means comprise a plurality of cog wheels arranged on an axis, said cog wheels forming the means for providing an engagement between said first rolling element and the endless belt. Other examples include toothed wheel adapted to engage the endless belt.

According to one embodiment, the means for providing an engagement between said second rolling element and said endless belt comprise projections arranged on at least one of the second rolling element and the endless belt and corresponding depressions arranged on at least one of the second rolling element and the endless belt. One example of such means are ribs extending along the second rolling element and/or carrying element and corresponding grooves arranged on the first side of the endless belt. In one embodiment, the grooves may be arranged on the rolling element and the ribs on the endless belt. The grooves and/or the ribs may be continuous along the length of the rolling element and/or the width of the belt, or may in some embodiments be discontinuous forming for example lugs or shoulders. In one embodiment, the second rolling element comprises a cog wheel shaped cross section, and the endless belt comprises a corresponding “gear rack” structure.

In one embodiment, both the first and the second rolling element comprise means for forming an engagement with the endless belt, the belt may comprise corresponding means.

According to one embodiment, the supporting structure comprises a base plate adapted to extend in a plane coinciding with a plane of an existing seat of a wheelchair, a first side element adapted to extend in a second plane perpendicular to said plane and a second side element adapted to extend in a third plane parallel to said second plane. The seat of the wheelchair may be an existing seat of a wheelchair. Accordingly, the supporting structure may be described as a somewhat box shaped structure comprising a bottom surface (i.e. the base plate) and a first and second side, said sides extending along the sides of the base plate in a direction substantially perpendicular to the axis of rotation of the first rolling element. In one embodiment, the seat may comprise a third and/or a fourth side extending between the base plate and the first and second side, at the front and rear sides of the base plate respectively. The height of the first and second side element may correspond at least to the diameter of the first rolling element.

According to one embodiment, the first and/or second rolling element are adapted to be rotatably arranged by means of said first and second side element. In one embodiment, such means may comprise a first hole arranged in the first side element, and a second hole arranged in the second side element, such that the axle of a rolling element may extend between the first and the second side element and be rotatably supported by the holes. According to one embodiment, at least one of the first and second side elements may comprise a slot, or an elongated opening arranged such that an axle of a rolling element may be introduced, or inserted through the slot and further rotatably supported by the slot. For example, the slot may be arranged at a first edge of the first and or second side element, and extend substantially horizontal such that an axle may be introduced, or inserted along the longitudinal direction of the slot. Such an embodiment advantageously facilitates assembly of the seat.

According to one embodiment, the means for applying a rotational motion to said at least one driving rolling element are arranged on a first side of one of the first and second side elements and said endless belt is arranged on a second side of said one of the first and the second side element. According to one embodiment, the user may be positioned on the second side of the side element. Accordingly, safety may be improved for the user. Further, in the exemplary case that a care giver handles the means for applying a rotational movement, convenience of handling is increased when the means, for example a handle, are arranged on for example what may be referred to as an outer side when the seat is arranged in the wheelchair. For example, with reference to the supporting structure described as a somewhat box shaped structure comprising a bottom surface (i.e. the base plate) and a first and second side, said sides extending along the sides of the base plate in a direction substantially perpendicular to the axis of rotation of the first rolling element, the base plate may be described as arranged on the second side. Accordingly, when in use, the means for applying a rotational motion to said at least one driving rolling element are arranged on what may be described as an outer side, i.e. the side of the seat facing a wheel. In some embodiments, the seat comprises first and second means for applying a rotational movement.

According to one embodiment the seat further comprises a seat supporting plate adapted to be arranged facing said inner side of said endless belt and further adapted to bear the weight of a user. In one embodiment, the seat supporting plate is supported by the first and second side elements. The seat supporting plate may be detachably attached to the first and/or second side element by means of for example screw joints. In some embodiments, the seat supporting plate may be fixedly attached by means of for example welding.

According to one embodiment, the seat further comprises a padding arranged along said endless belt. Such padding provides enhanced comfort to the user. The padding may be arranged along the full length of the endless belt, or along a portion of the endless belt. In some embodiments, the padding may be provided in the form of a loop of padding, i.e. and “endless” padding adapted to be arranged on, or along, the endless belt. The padding may for example comprise foam or foam rubber. In some embodiments, the padding may comprise special material adapted to reduce pressure comprising for example gels, fluids or air cells or chambers.

According to one embodiment, the padding is removably arranged. In some embodiments, the padding may for example be removably arranged by means of a form fit or a frictional engagement

According to one embodiment, the padding further comprises fastening means for securing said padding to the endless belt. Such means may comprise for example straps or Velcro. Preferably, the fastening means provide a detachable attachment, or engagement, between the padding and the belt.

According to one embodiment, the means for applying a rotational motion to at least said driving pulley/rolling element is a manual operable means. Examples of manual means include a lever, a handle, a crank, or a hand grip by means of which the user and/or a care giver may rotate the rolling element and consequently provide a rotation about the first rolling element and the carrying element to the endless belt. According to one embodiment, the means for applying a rotational motion to said at least one drive rolling element comprise a motor. Examples of such a motor providing automatic means include an electric motor adapted to apply a rotation to the first rolling element. Such means may further comprise a control unit and a user interface.

According to one embodiment, the seat comprises means for securing said seat to a wheelchair. Examples include straps or Velcro. In some embodiments, a suitable joint comprising a snap lock may be arranged between the wheelchair and the seat, such that the seat may be easily and quickly secured to and removed from the wheelchair. Said means are preferably adapted to provide a detachable engagement between the seat and the wheelchair.

According to one embodiment, the endless belt is adapted to rotate about said first rolling element and said carrying element solely in a first direction of rotation. For example, the first direction of movement may be a direction of movement wherein the user, after sliding forwards in the wheelchair, is transferred back to a proper seating position. One advantage of such an embodiment is that the risk of the endless belt, and consequently the user, slides in a not desired second opposite direction due to for example a slip in the engagement between the first rolling element and the endless belt is reduced.

In one embodiment, the means for applying a rotational movement to the first rolling element may comprise a ratchet, i.e. a mechanical device that allows rotary motion in only one direction while preventing motion in the opposite direction. Accordingly, in some embodiments, the means for applying a rotational movement to the first rolling element may further comprise means for stopping, or preventing, a movement such as a rotational movement. For example, the means for applying a rotational movement to the first rolling element may apply a rotation movement in a first direction and prevent movement in a second opposite direction.

According to one embodiment, the length of the seat along the direction F/R defined as the forward/rearward direction, i.e. the length of the seat, lies in the range of 0-100 cm. In one embodiment, the length of the seat as defined above lies in the range of 20-70 cm. A further exemplary range in which the length of the seat may lie is the range of 30-60 cm.

According to one embodiment, the length of the seat along the direction T defined as the transverse direction, i.e. the width of the seat, lies in the range of 0-100 cm. In one embodiment, the width of the seat as the defined above may lie in the range of 20-60 cm. A further exemplary range in which the width of the seat may lie is the range of 30-55 cm.

According to one embodiment, the length of the seat along the direction V defined as the vertical direction, i.e. the height of the seat, lies in the range of 0-30 cm. In one embodiment, the height of the seat as defined above lies in the range of 0-15 cm. A further exemplary range in which the height of the seat may lie is the range 5-10 cm.

According to a second aspect of the present invention, a wheelchair comprising a seat according to any of the embodiments described in the foregoing is provided. The seat may for example be provided as a fixed seat, in a sense replacing a conventional, or existing, seat of the wheelchair. In some embodiments, the seat may be adapted to be arranged on, or rest on, an existing seat of the wheelchair. Objectives, advantages and features of such a wheelchair conceivable within the scope of the second aspect of the invention are readily understood by the foregoing discussion referring to the first aspect of the invention.

According to a third aspect of the present invention, a method for adjusting of the position of a user in a wheelchair s provided, the method comprising: placing a seat according to any of the embodiment described above in a wheelchair, positioning of a user on the seat, adjusting the position of the user. Objectives, advantages and features of the method conceivable within the scope of the third aspect of the invention are readily understood by the foregoing discussion referring to the first aspect of the invention.

According to a fourth aspect of the invention, an adjustable bearing structure for a bed is provided, the bearing structure being adapted to be removably arranged in the bed. The bearing structure may be similarly configured as the seat described with reference to any of the embodiments above. For example, the bearing structure comprises a first rolling element, a carrying element, a supporting structure adapted to support said first rolling element and said carrying element, an endless belt, said belt comprising an inner and an outer surface, said inner surface being adapted to face said first rolling element and said carrying element, at least one of the first rolling element and the endless belt further comprising means for providing an engagement between said first rolling element and said endless belt, and means for applying a rotational motion to said first rolling element. Wherein the first rolling element is arranged to be rotatably supported by said supporting structure, the endless belt is adapted to rotate about said first rolling element and said carrying element, and the first rolling element is a drive rolling element such that a rotational movement of said endless belt about said driving rolling element and said carrying element may be induced by means of said means for applying a rotational motion to said at least one first rolling element.

Objectives, advantages and features of the bearing structure conceivable within the scope of the third aspect of the invention are readily understood by the foregoing discussion referring to the first aspect of the invention.

Further objectives of, features of and advantages with the present invention will become apparent when studying the following detailed disclosure, the drawings and the appended claims. Those skilled in the art realize that different features of the present invention can be combined to create embodiments other than those described in the following.

### BRIEF DESCRIPTION OF THE DRAWINGS

The invention will be better understood through the following illustrative and non-limiting detailed description of preferred embodiments, with reference to the appended drawing, on which:

FIG. 1 is a perspective view of a seat according to one embodiment arranged in a wheelchair;

FIG. 2 is a perspective view of a seat for a wheelchair according to one embodiment of the invention;

FIG. 3 is an exploded perspective view of a seat for a wheelchair according to one embodiment of the invention;

FIG. 4 is a perspective partial view showing a detail of the seat according to one embodiment.

All figures are schematic, not necessarily to scale, and generally only show parts which are necessary in order to elucidate the invention, wherein other parts may be omitted or merely suggested.

### DETAILED DESCRIPTION OF EMBODIMENTS

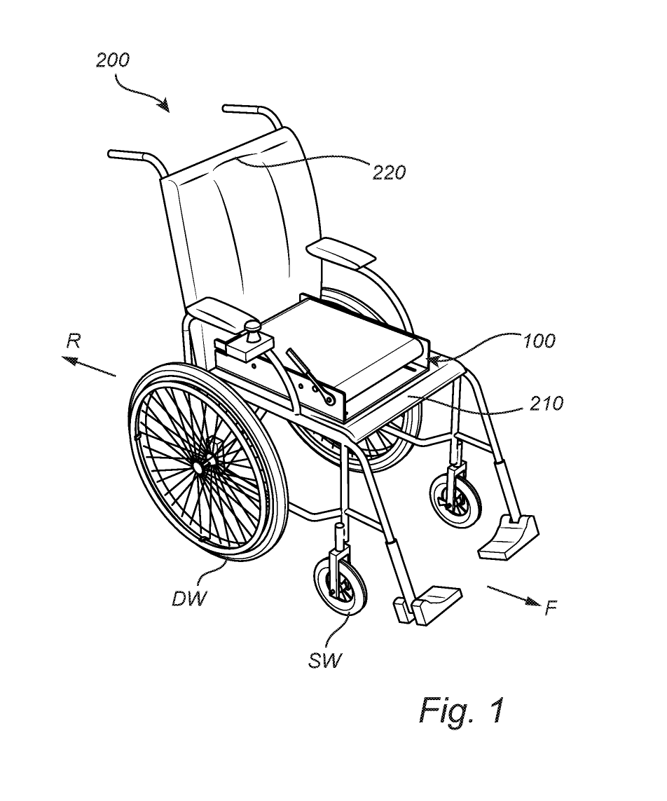

FIG. 1 shows the seat 100 arranged in a wheelchair 200 according to one embodiment corresponding to the second aspect of the present invention. The wheelchair may comprise two driving wheels DW and two smaller wheels SW, a seating structure 210 and a backrest 220. The seat 100 may be arranged on the seating structure 210 and may be secured to the wheelchair using suitable fastening means (not shown). Further, the forward direction F and rearward direction R of the wheelchair are illustrated in FIG. 1.

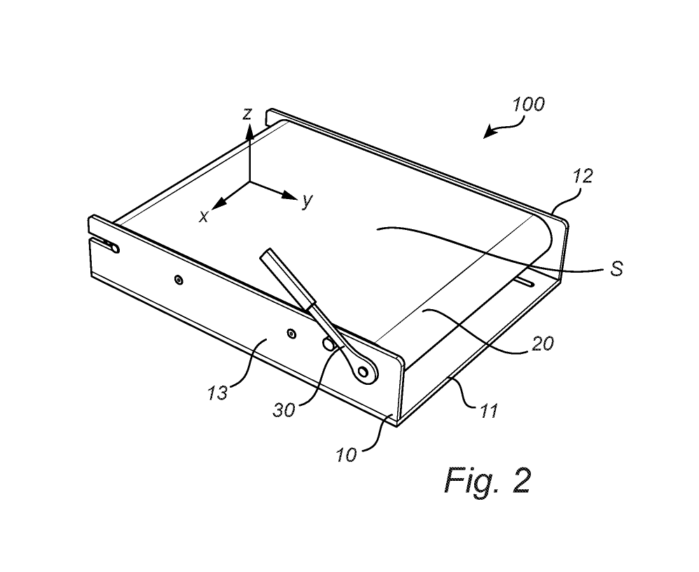

An exemplary embodiment of the assembled seat 100 is shown in more detail in FIG. 2. The seat comprises a supporting structure 10, an endless belt 20 and means 30 for applying a rotational motion to said endless belt by means of a first rolling element 40 (not shown). The supporting structure comprises a base plate 11, a first side element 12 and a second side element 13. A seating area S is provided on a portion of the endless belt, the seating area S extends between said first and second side element 12, 13. Further, FIG. 1 shows a coordinate system, wherein the direction x is a longitudinal direction of the endless belt and of the seat, the direction y corresponds to a lateral direction of the seat, and the direction z to a vertical direction of the seat.

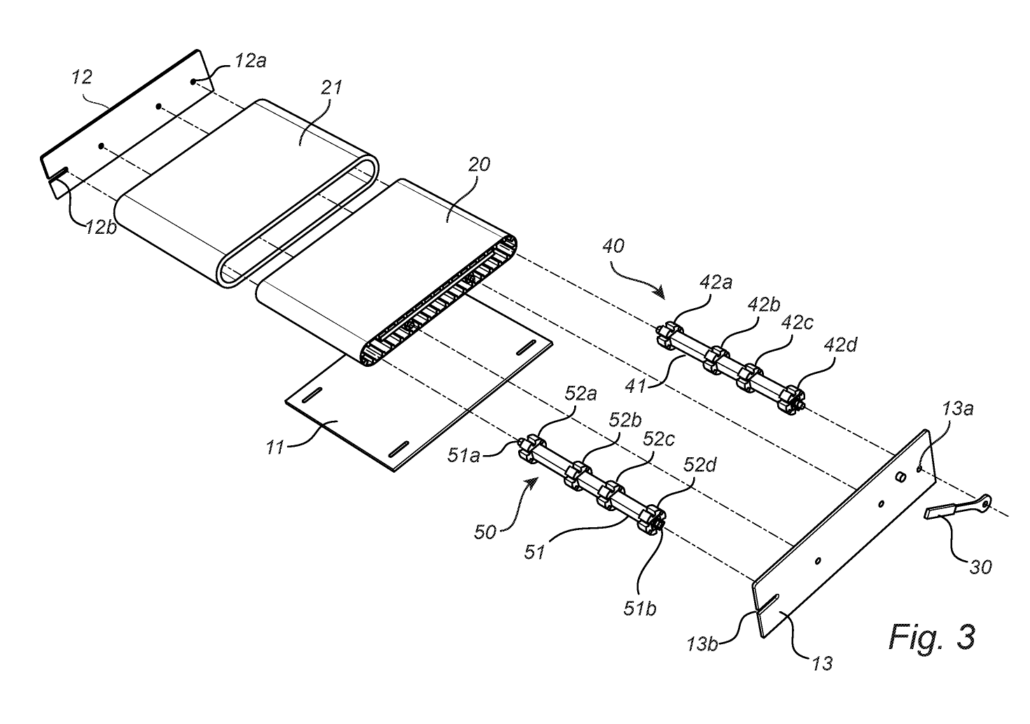

FIG. 3 shows an exploded seat 100, or seat assembly, according to one embodiment. The seat 100 comprises the supporting structure 10 comprising a base plate 11, a first side element 12 and a second side element 13, an endless belt 20 and a padding 21 adapted to be arranged on, or along, the endless belt 20, i.e. along an outer side of the endless belt 20. The padding may comprise substantially the same shape as the endless belt and comprise for example foam. Further, FIG. 2 shows a first rolling element 40 and a carrying element/second rolling element 50. The first rolling element 40 is a drive rolling element, i.e. the first rolling element 40 is adapted to induce a rotational movement to the endless belt 20. The rotational movement is provided to the first rolling element 40 by means of the therefore designed means 30 comprising a handle 31.

The first rolling element 40 comprises an axle 41 comprising a first and a second end 41a, 41b. The first rolling element 40 further comprises means 42 for engaging with the endless belt 20. In the illustrated case means 42 comprise 4 cog wheels, or cog wheel like structures, 42a-d arranged on the axle 41. The cog wheels 42a-d are arranged to rotate with the axle 41. In the illustrated embodiment, the cog wheels are fixedly arranged on the axle 41.

Similarly, the second rolling element 50 comprises an axle 51 comprising a first and a second end 51a, 51b. The second rolling element 50 further comprises means 52 for engaging with the endless belt 20. In the illustrated case means 52 comprise 4 cog wheels, or cog wheel like structures, 52a-d arranged on the axle 51. The cog wheels 52a-d are arranged to rotate with the axle 51. In the illustrated embodiment, the cog wheels are fixedly arranged on the axle 51.

The cog wheels 42a-d, 52a-d may also be referred to as toothed wheels.

The first and second rolling element 40, 50 are arranged to be supported by, and between, the first and second side element 12, 13.

The first end 41b of the first rolling element 40 is adapted to be arranged in, or insert through, a hole 12a in the first side element 12, the second end 41b is adapted to be arranged in a hole 13a of the second side element 13. Hereby the axle 41 is adapted to extend between the first and second side element and to be rotatably supported by the side elements 12, 13. Suitable means for facilitating rotation of the axle 41 may be arrange on the axel 41 and/or at the holes 12a, 13a. Examples include different types of bearings.

The first end 51b of the first rolling element 50 is adapted to be arranged in, or insert through, a slot 12b in the first side element 12, the second end 51b is adapted to be arranged in a slot 13b of the second side element 13. The respective slots 12b, 13b extend substantially horizontally from an edge of the first and second side elements 12, 13, i.e. the slots 12b, 13b comprises an open end such that the axle 51 may be received by, or inserted into, the slots and rotatably supported. Suitable means for facilitating rotation of the axle 51, such as bearings, may be arrange on the axel 51. Hereby the axle 51 is adapted to extend between the first and second side element and to be rotatably supported by the side elements 12, 13.

The means 30 for inducing a rotational movement are arranged at the first side element adjacent to hole, or aperture, 12a. The means 30 are further arranged to drive the first rolling element 40, i.e. to induce a rotational movement to the first rolling element 40. In the illustrated embodiment, the handle 31 is attached to the axle 41. The axle 41 extends through the hole 12a such that the handle may be attached to the protruding portion of the axle 41. The engagement of the handle 31 and the axle 41 in the illustrated embodiment is such that rotary motion is allowed in one direction while prevented in the opposite direction, i.e. the engagement comprises a ratchet.

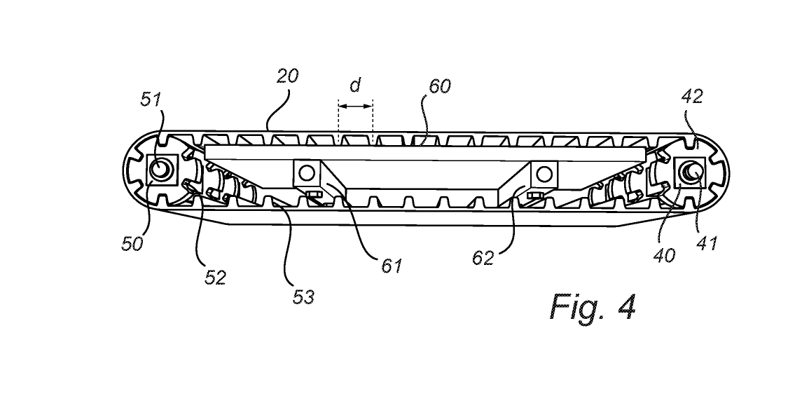

The function of the seat will now be described with reference to FIG. 4. FIG. 4 is a side view of endless belt 20, a seat supporting plate 60 and the first and second rolling element 40, 50. The seat supporting plate 60 extends between the first and second side element 12, 13 and faces, or is arranged adjacent to, the inner side 21 of the endless belt and is further adapted to bear the weight of a user. The seat supporting plate is supported by the first and second side elements 12, 13 by means of beams 61, 62 arranged to extend between and to be attached to the first and second side elements 12, 13. The beams 61, 62 may be attached to the plate 60 by means of screw joints.

The endless belt 20 comprises a plurality of protrusions 53 arranged on the inner side 51 facing the first and second rolling element, and the engagement elements 42a-d and 52a-d comprised by the respective rolling element 40, 50. The belt comprises, or is made from, a soft and flexible material such as a durable plastic or rubber. The distance d between adjacent protrusions corresponds to the distance between adjacent depressions of the engagement elements 42a-d and 52a-d, i.e. the adjacent grooves of the cogwheels 42a-d and 52a-d. Accordingly, each cog of the cog wheels 42a-d, 52a-d have a length corresponding to the distance between adjacent protrusions of the endless belt. Hereby an engagement may be formed between the endless belt 20 and the first and second rolling element 40, 50 such that the endless belt may rotate about the first and second rolling element 40, 50. In the illustrated embodiment, the first rolling element 40 drives the endless belt, i.e. is a driving rolling element.

A further embodiment (not shown), conceivable within the scope of the claims is an embodiment wherein the second rolling element 50 is replaced by a carrying element 50 fixed to the first and second side element. I.e. a stationary, non-rotating carrying element 50.

In use, the seat is placed in a wheelchair, as shown for example in FIG. 1. A user is initially seated on the seat in what may be referred to as a proper initial position wherein the bottom and thighs of the user are supported by the seat and the back is rested on and substantially parallel to the back rest. As is commonly the case, for example among elderly user, the user tend to over time involuntary slide forwards over the seat, i.e. in the direction F. Accordingly, after a period of time, the user may be positioned in a less favourable position wherein the behind of the user has moved forwards towards a front edge of the seat and the thighs are no longer properly supported by the seat. The user may maintain contact with the backrest, such that an inclined extension of the back arises, i.e. the back of the user extends between a forward position of the seat and the backrest in an unfavourable position not providing proper support for the back of the patient. The user, or a care giver, may now deploy or actuate, the handle 31 in order to apply a rotational movement to the first rolling element, whereby a rotational movement of the endless belt 20 about the first rolling element 40 and the second rolling element 50 is induced such that the user is translated in the rearward direction R until arriving at the initial, desired seating position again.

While the invention has been illustrated and described in detail in the drawings and foregoing description, such illustration and description are to be considered illustrative or exemplary and not restrictive; the invention is not limited to the disclosed embodiments. For example, the seat or a similar structure, may be used in a bed. The skilled person understands that many modifications, variations and alterations are conceivable within the scope as defined in the appended claims.

Additionally, variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope of the claims.

1. An adjustable seat for a wheelchair, said seat being configured to be removably arranged in said wheelchair, said seat comprising:
a first rolling element;
a carrying element;
a supporting structure configured to support said first rolling element and said carrying element;
an endless belt, said endless belt comprising an inner and an outer surface, said inner surface being configured to face said first rolling element and said carrying element, at least one of the first rolling element and the endless belt further comprising means for providing an engagement between said first rolling element and said endless belt; and
means for applying a rotational motion to said first rolling element, wherein at least a portion of said first rolling element is arranged to be rotatably supported by said supporting structure, wherein said endless belt is configured to rotate about said first rolling element and said carrying element, and wherein said first rolling element is a drive rolling element configured to transfer the rotational motion induced by said means for applying the rotational motion to said first rolling element to said endless belt.

2. The adjustable seat according to claim 1, wherein said carrying element is a second rolling element rotatably supported by said supporting structure.

3. The adjustable seat according to claim 1, wherein at least one of the second rolling element and said endless belt further comprises means for providing an engagement between said second rolling element and said endless belt.

4. The adjustable seat according to claim 1, wherein said means for providing the engagement between said first rolling element and said endless belt comprise projections arranged on at least one of the first rolling element and the endless belt and corresponding depressions arranged on the at least one of the first rolling element and the endless belt.

5. The adjustable seat according to claim 3, wherein said means for providing the engagement between said second rolling element and said endless belt comprise projections arranged on at least one of the second rolling element and the endless belt and corresponding depressions arranged on the at least one of the second rolling element and the endless belt.

6. The adjustable seat according to claim 1, wherein said supporting structure comprises;
a base plate configured to extend in a plane coinciding with a plane of the said seat of the wheelchair;
a first side element configured to extend in a second plane perpendicular to said plane; and
a second side element configured to extend in a third plane parallel to said second plane.

7. The adjustable according to any of claims 6, wherein said means for applying the rotational motion to said at least one drive rolling element are arranged on a first side of one of the first and second side elements and said endless belt is arranged on a second side of said one of the first and the second side element.

8. The adjustable seat according to claim 6, wherein said means for applying a rotational motion to said at least one drive rolling element are arranged on a first side of one of the first and second side elements and said endless belt is arranged on a second side of said one of the first and the second side element.

9. The adjustable seat according to claim 1, wherein said seat further comprises a seat supporting plate configured to be arranged facing said inner surface of said endless belt and further configured to bear a weight of a user.

10. The adjustable seat according to claim 1, further comprising a padding arranged along said endless belt.

11. A wheelchair comprising a seat, wherein said seat is configured to be removably arranged in said wheelchair, said seat comprising:
a first rolling element;
a carrying element;
a supporting structure configured to support said first rolling element and said carrying element;
an endless belt, said endless belt comprising an inner and an outer surface, said inner surface being configured to face said first rolling element and said carrying element, at least one of the first rolling element and the endless belt further comprising means for providing an engagement between said first rolling element and said endless belt; and
means for applying a rotational motion to said first rolling element, wherein at least a portion of said first rolling element is arranged to be rotatably supported by said supporting structure, wherein said endless belt is configured to rotate about said first rolling element and said carrying element, and wherein said first rolling element is a drive rolling element configured to transfer the rotational motion induced by said means for applying the rotational motion to said first rolling element to said endless belt.

12. The wheelchair according to claim 11, wherein said carrying element is a second rolling element rotatably supported by said supporting structure.

13. The wheelchair according to claim 11, wherein at least one of the second rolling element and the endless belt further comprises means for providing an engagement between said second rolling element and said endless belt, wherein said means for providing an engagement between said second rolling element and said endless belt comprise projections arranged on at least one of the second rolling element and the endless belt and corresponding depressions arranged on the at least one of the second rolling element and the endless belt.

14. The wheelchair according to claim 11, wherein said means for providing an engagement between said first rolling element and said endless belt comprise projections arranged on at least one of the first rolling element and the endless belt and corresponding depressions arranged on the at least one of the first rolling element and the endless belt.

15. The wheelchair according to claim 11, wherein said supporting structure comprises;
a base plate configured to extend in a plane coinciding with a plane of the said seat of the wheelchair;
a first side element configured to extend in a second plane perpendicular to said plane; and
a second side element configured to extend in a third plane parallel to said second plane.

16. The wheelchair according to claim 15, wherein said means for applying a rotational motion to said at least one drive-rolling element are arranged on a first side of one of the first and second side elements and said endless belt is arranged on a second side of said one of the first and the second side elements.

17. The wheelchair according to claim 15, wherein said means for applying a rotational motion to said at least one drive rolling element are arranged on a first side of one of the first and second side elements and said endless belt is arranged on a second side of said one of the first and the second side elements.

18. The wheelchair according to any of claims 15, wherein said seat further comprises a seat supporting plate adapted to be arranged facing said inner surface of said endless belt and further configured to bear a weight of a user.

19. The wheelchair according to claim 11, further comprising a padding arranged along said endless belt.

20. An adjustable seat comprising:
a first rolling element;
a carrying element;
a supporting structure configured to support said first rolling element and said carrying element;
a belt, said belt comprising an inner and an outer surface, said inner surface being configured to face said first rolling element and said carrying element, at least one of the first rolling element and the belt further comprising a frictional engagement device configured to attach said first rolling element to said belt; and
at least one of a manual crank or a motor configured to apply a rotational motion to said first rolling element, wherein at least a portion of said first rolling element is arranged to be rotatably supported by said supporting structure, wherein said belt is configured to rotate about said first rolling element and said carrying element, and wherein said first rolling element is configured to transfer the rotational motion induced by the at least one of the manual crank or the motor to said belt.
